(19) United States
(12) Patent Application Publication
(10) Pub. No.: US 2014/0027249 A1
(43) Pub. Date: Jan. 30, 2014

(54) BELT GUIDE DEVICE FOR USE IN CONVEYOR BELTS

(71) Applicant: VALE S.A., Rio de Janeiro (BR)

(72) Inventors: Antonio Marcos Torres CRUZ, Vila Velha (BR); Bruno Freitas Hortencio, Serra (BR); Glausco Santana, Cariacica (BR); José da Paz Correa, JR., Serra (BR); Patrick Farias Rissi, Vila Velha (BR); Sérgio Gonçalves De Azevedo, Serra (BR); Ulisses Chaves Da Silva, Serra (BR)

(73) Assignee: VALE S.A., Rio de Janeiro (BR)

(21) Appl. No.: 13/951,260

(22) Filed: Jul. 25, 2013

(30) Foreign Application Priority Data
Jul. 25, 2012 (BR) PI 102012018473-7

(51) Int. Cl. B65G 15/60

(52) U.S. Cl. CPC B65G 15/60
USPC 198/842

(57) ABSTRACT

The present invention refers to a belt guide device for use in conveyor belts and, more specifically, to a guide roller device that decreases the need to replace the rollers and prevents the formation of rubber strips by contact between the belt of the conveyor and the roller. Thus, the device of the present invention comprises: the guide roller, a sliding board whereon the guide roller is mounted, a support track that receives the sliding board, and an adjustment mechanism connected to the sliding board to trigger, selectively, the sliding thereof in relation to the support track. The support track is fastened to the structure in a position such that the guide roller is situated closely adjacent to the edge of the belt.

### FIELD OF THE INVENTION

The present invention refers to a belt guide device for use in conveyor belts and, more specifically, to a guide roller device that decreases the need to replace guide rollers and prevents the formation of rubber strips by contact between the belt and the roller.

### BACKGROUND OF THE INVENTION

Conveyor belts solutions are broadly known in the art for the transport of articles from one place to another. Said solutions basically comprise a conveyor/belt made of rubber or other suitable material which moves propelled by rollers or other drive devices. A support, generally in the shape of a table, trough or easel, supports the drive rollers and other structures required for the working of the conveyor belt (load rollers, return rollers, curve devices, smaller easels, etc.).

In order to guarantee the belt path and to prevent misalignment during its movement, guide rollers may be provided adjacent to the belt edges. Said guide rollers are generally disposed at the lower portion or return portion of the belt (that is, at the portion of the belt which moves in the opposite direction to the transport). However, said rollers may also be provided in the upper portion of the slipway, if the project so requires. This is the case, for example, of belts that slide on rollers with very far spacing.

Conveyor belts are broadly used in the transport of bulk materials, such as, for example, materials originating from mining. In the case of transporting minerals, the conveyor or belt per se must be made of a material strong enough to support the continuous load of heavy materials. Thus, belts are generally made of reinforced rubber, such as, for example, vulcanized rubber.

It so happens that the use of a reinforced material for the belt represents a greater strain on the components in contact therewith. In the case of guide rollers, this is especially true, since the edge of the belt may press the surface of the rollers with significant force, and even prevent movement thereof and cause pieces of belt to be torn off the edge.

Thus, there are at least two problems commonly associated to guide rollers: the heavy wear and tear of the surface of the guide roller in contact with the belt, and the formation of rubber strips by “unpeeling” of the edges of the belts.

These problems represent major operational drawbacks, since they decrease the useful life of the rollers—forcing constant replacements—and damage the belt of the conveyor. Additionally, the “unpeeling” of the edges of the belts may cause the material transported to fall inadvertently through the gap formed where the rubber was torn, causing a significant operational loss.

Some known solutions in the state of the art are designed to mitigate the drawback associated to the constant replacement of the guide rollers by way of devices that enable easier roller installation. This is the case, for example, of the solution described in document KR20110026063, where the guide roller is mounted on a support and may be accessed by the outer wall of the support, decreasing the possibility of damage to the belt caused by mounting and dismounting of the roller.

Said known solutions, however, are merely palliative solutions that just treat the effects of the problem found in the use of conventional guide rollers, without solving the causes of the problem.

### OBJECTIVES OF THE INVENTION

In light of the above, it is one of the objectives of the present invention to provide a belt guide device for use in conveyor belts that solves, or at least considerably diminishes, the drawbacks associated to the use of belt guide rollers.

It is another objective of the present invention to provide a belt guide device capable of preventing the formation of belt strips through contact between the belt and the roller, increasing the useful life of the belt and decreasing the risk of accidents caused by loose belt strips.

It is a further objective of the present invention to provide a belt guide device that decreases the need for constant replacement of the belt guide roller, increasing the operating efficiency and decreasing the risk of accidents associated to said maintenance or replacement.

It is yet another objective of the present invention to provide a belt guide device capable of decreasing the wear and tear of the surface of the belt guide roller.

It is still a further objective of the present invention to provide a belt guide device capable of decreasing the possibility of loss of the material transported by falling through the empty spaces left by strips torn off the belt.

### SUMMARY OF THE INVENTION

The present invention achieves the above objectives by means of a belt guide device for use in a conveyor belt of the type that comprises a belt and a support structure, the device comprising:

a guide roller;

a sliding board whereon the guide roller is mounted;

a support track that receives the sliding board; and

an adjustment mechanism connected to the sliding board to trigger, selectively, the sliding thereof in relation to the support track.

The support track is fastened to the structure in a position such that the guide roller is situated closely adjacent to the edge of the belt.

In the preferred embodiment of the present invention, the adjustment mechanism is a rod that extends longitudinally from one end of the sliding board, and the support track has a hollowed handle that enables the passage of the rod and assures its stability.

Preferably, the rod takes the shape of a spindle which is fastened to the sliding board by means of a nut.

Further in the preferred embodiment, the support track comprises overlapping longitudinal wings that form spaces to receive the corresponding longitudinal edges of the sliding board, and the support track is a lubricated track.

### BRIEF DESCRIPTION OF THE DRAWINGS

The drawings show:

FIG. 1—FIG. 1 illustrates a preferred embodiment of the belt guide device according to the present invention, the device being installed on a conventional conveyor belt, and only a part of the conveyor is illustrated;

FIG. 2—FIG. 2 shows a perspective view of the device according to a preferred embodiment of the present invention;

FIG. 3—FIG. 3 shows a front-raised view of the device according to a preferred embodiment of the present invention;

FIG. 4—FIG. 4 shows a front view of the support track of the device according to a preferred embodiment of the present invention;

FIG. 4A—FIG. 4A and a side view of the track shown in FIG. 4;

FIG. 5—FIG. 5 shows a rear view of the sliding board of the device according to a preferred embodiment of the present invention;

FIG. 5A—FIG. 5A is a side view of the board shown in FIG. 5;

FIG. 6—FIG. 6 illustrates an upper view of the guide roller of the device according to a preferred embodiment of the present invention;

FIG. 6A—FIG. 6A is a side view of the guide roller shown in FIG. 6.

### DETAILED DESCRIPTION OF THE INVENTION

The present invention will now be described in greater detail based on an example of execution represented in the drawings.

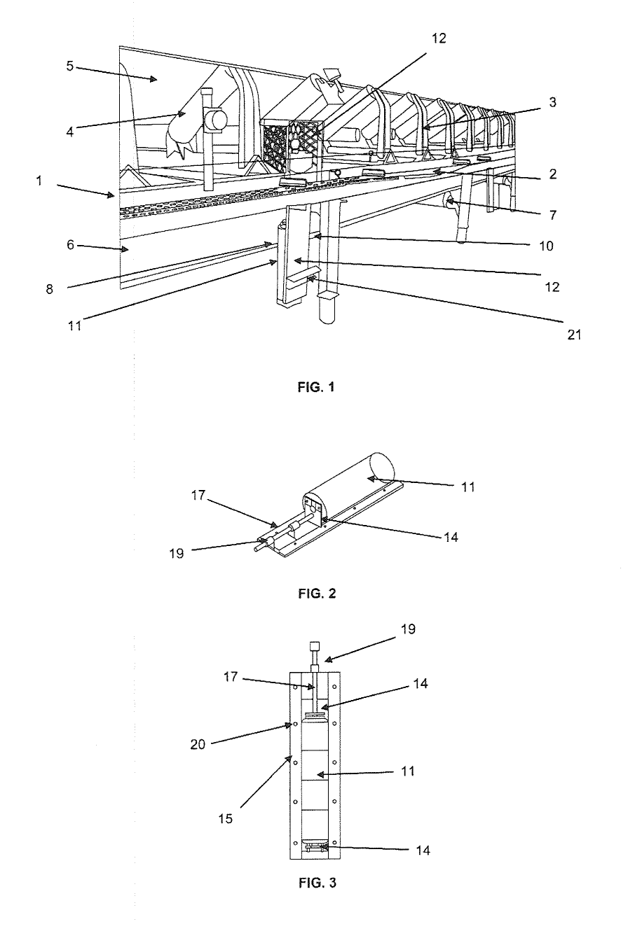

FIG. 1 shows a part of a conveyor belt 1 having a support structure 2 whereon there are mounted the easels that support a plurality of load rollers 4.

The load rollers 4 support the portion of the conveyor belt 5 that moves in the direction of the transport of the material. The load rollers are resistant enough to support not only the belt but also the weight of the material transported thereon.

The return portion of the belt 6 moves in the direction opposite that of the transport. Return rollers 7 are provided to support the return portion of the belt 6.

The return rollers 7 are generally more spaced than the load rollers 4, such that the presence of guide rollers is necessary to prevent diversion or misalignment of the belt 6. The guide rollers rotate on their own axis, so as to accompany the movement of the belt.

The present invention therefore pertains to a guide device 10 that comprises at least one guide roller 11. The device of the present invention is disposed adjacent to the edge 8 of the belt 6 so as to contact said edge in case of diversion in the trajectory of the belt.

In its preferred embodiment, the device of the present invention comprises a support track 12 which is fixed to the support structure of the conveyor.

FIGS. 2 to 6 show in greater detail the device 10 according to a preferred embodiment of the present invention.

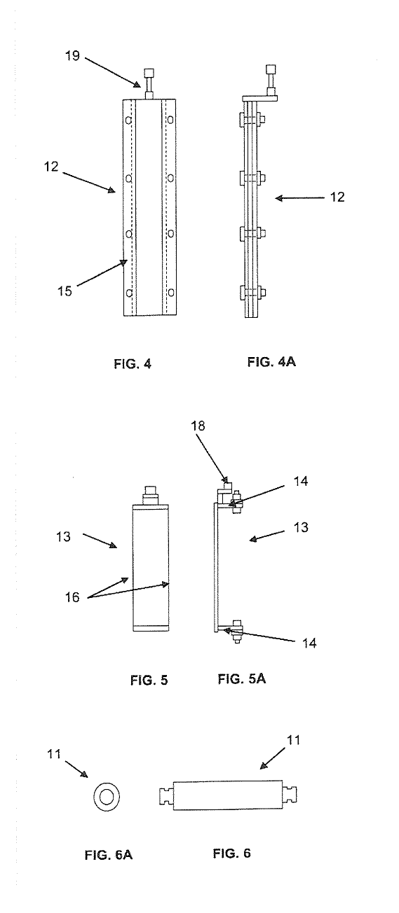

Besides the support track 12 (better illustrated in FIGS. 4 and 4A), the device comprises a sliding board 13 (better illustrated in FIGS. 5 and 5A) having means 14 to fasten the guide roller 11.

The support track 12 has overlapping wings 15 that define a reception space and slides to longitudinal edges 16 of the sliding board 13.

Accordingly, after fastening the roller 11 on the board 13, the board may be inserted by the upper end part of the support track 12 and is slidingly incased in relation to the track 12.

Fastening bolts 20 can be used to fasten the wings 15. However, it must be emphasized that the overlapping wings 15 could be replaced by wings facing inwards, integrating the body of the track 12.

An axle or tubular rod 17 is connected to the sliding board 13. Thus, a connector 18 is provided on the board 13 to fasten the rod 17.

In the preferred embodiment of the invention shown in the drawings, the rod 17 is a spindle of approximately 500 mm in length, and the connector 18 is a nut welded to the board 13.

A hollowed handle 19 may be provided at the end of the support track 12, so as to enable the passage of the rod 17, assuring its stability.

Thus, in the preferred embodiment shown in the figures, the rod or spindle 17 is passed through the handle 19, and the spindle 17 is then screwed to the connector or nut 18.

It must be emphasized that the rod tubular 17 could be replaced by any other mechanism that enables longitudinal (vertical) displacement adjustment (sliding) of the sliding board 13.

Fastening the guide device 10 of the present invention to the support structure 2 of the conveyor 1 may be carried out by any suitable means, provided that the surface of the guide roller 11 is closely adjacent to the edge of the belt 5.

The guide device of the present invention is preferably mounted as follows:
the guide roller 11 is fastened to the sliding board 13 by way of the fastening means 14 provided on the board 13;
the rod or adjustment mechanism for longitudinal (vertical) movement 17 is fastened to the sliding board 13, preferably by a connector element 18;
the board/rod/guide roller combination is inserted onto the support track 12, so that it may displace longitudinally (vertically) in relation thereto.

Since the board/rod/roller combination may displace longitudinally over the track 12, an operator may easily adjust the position longitudinal (vertical) of the roller by raising or lowering the rod 17 vertically. As mentioned previously, in the preferred embodiment of the present invention, regulating the displacement of the board/rod/roller combination over the track 12 may be performed by a spindle-nut system, where the rod 17 is the spindle and the connector 18 the nut.

In order to prevent the system from becoming unset due to the vibrations of the combination, a lock nut may be provided above the handle 19. The lock nut (not illustrated) gives stability to the spindle-nut fastening 17, 18.

The rod 17 is sized so that its end projects in relation to the support structure of the conveyor, enabling easy access by the operator.

The longitudinal (vertical) movement of the guide roller 11—possible in the device 10 of the present invention—enables the roller to be selectively and quickly adjusted so that different portions of its surface contact the edge of the belt. Thereby, the entire surface of the roller may be used, without the need for replacement when only one area of the surface becomes worn.

In the preferred embodiment of the present invention, the track 12 is lubricated with grease or any other suitable lubricant, so as to facilitate the displacement of the mobile combination (board/rod/guide roller). The lubricant may be, for example, applied with a brush directly on the tracks 12. Preferably, lubrication is performed periodically—for example, every six months—and also after replacement of the guide roller.

In the preferred embodiment shown in FIG. 1, a fastening structure in the form of a board 21 is provided to connect the lower part of the device 10 to the support structure 2. Preferably, fastening is by vertical pillars of the support structure 2.

Further in the preferred embodiment, a protection structure 22 is provided to avoid damage to the operator when adjusting the position of the roller 11. As illustrated in FIG. 1, the protection structure may be in the shape of a protection grid 22 fastened to the support structure 2.

It must be understood that the drawings show a preferred embodiment of the guide device of the present invention, and the real scope of the object of the invention is defined in the accompanying claims.

1. A belt guide device for use in a conveyor belt of the type that comprises a belt and a support structure, the belt comprising an edge, the device comprising:
a guide roller;
a sliding board whereon the guide roller is mounted;
a support track which receives the sliding board; and
an adjustment mechanism connected to the sliding board to trigger, selectively, the sliding thereof in relation to the support track;
wherein the support track is fastened to the support structure in a position such that the guide roller is situated closely adjacent to the edge of the belt.

2. The device of claim 1, wherein the adjustment mechanism comprises a rod which extends longitudinally from one end of the sliding board.

3. The device of claim 2, wherein the rod comprises a spindle that is fastened to the sliding board.

4. The device of claim 2, wherein the support track comprises a hollowed handle which enables passage of the rod and assures its stability.

5. The device of claim 1, wherein the support track comprises overlapping longitudinal wings which form spaces to receive corresponding longitudinal edges of the sliding board.

6. The device of claim 1, wherein the support track is lubricated.
